(19) United States
(12) Patent Application Publication
(10) Pub. No.: US 2015/0002113 A1
(43) Pub. Date: Jan. 1, 2015

(54) POWER SUPPLY CIRCUIT

(71) Applicant: KABUSHIKI KAISHA TOSHIBA, Tokyo (JP)

(72) Inventor: Takayuki MIYAZAKI, Tokyo (JP)

(73) Assignee: KABUSHIKI KAISHA TOSHIBA, Tokyo (JP)

(21) Appl. No.: 14/191,318

(22) Filed: Feb. 26, 2014

(30) Foreign Application Priority Data
Jun. 28, 2013 (JP) 2013-136333

(51) Int. Cl. H02M 3/158; H02M 3/156

(52) U.S. Cl. CPC H02M 3/158; H02M 3/156
USPC 323/271; 323/284

(57) ABSTRACT

A power supply circuit includes a first switch, a second switch, an inductor, a series circuit, a second resistor, and a control signal circuit. The first and second switches are connected between a first terminal and a second terminal and to each other at an output node. The inductor is connected between the output node and an output terminal. The series circuit is connected in parallel with the inductor and includes a first resistor and a capacitor connected to each other at a common connection node. The second resistor is connected in parallel with the capacitor. The control signal circuit compares a voltage at the common connection node to a reference voltage to generate a control signal for at least the first switch based on the comparison.

### CROSS-REFERENCE TO RELATED APPLICATION

This application is based upon and claims the benefit of priority from Japanese Patent Application No. 2013-136333, filed Jun. 28, 2013, the entire contents of which are incorporated herein by reference.

### FIELD

Embodiments described herein relate generally to a power supply circuit.

### BACKGROUND

In the related art, a technology for feeding back the output voltage of a power supply circuit, comparing the output voltage with a reference voltage, and performing control such that the output voltage becomes a predetermined voltage, is known.

However, in a power supply circuit whose output voltage is supplied to a load through an inductor, the output voltage is influenced by the inductor. More specifically, a drop in voltage due to equivalent series resistance of the inductor causes an error in the output voltage. For this reason, a power supply circuit that is capable of suppressing influence of an inductor to appropriate amount is desired.

### DESCRIPTION OF THE DRAWINGS

FIG. 1 is a view illustrating a power supply circuit according to a first embodiment.

FIG. 2 is a view for explaining the relation between the ratio of resistors and the degree of influence of an inductor.

FIG. 3 is a view illustrating a power supply circuit according to a second embodiment.

FIG. 4 is a view illustrating a power supply circuit according to a third embodiment.

### DETAILED DESCRIPTION

Embodiments provide a power supply circuit capable of reducing the influence of an inductor connected to an output terminal and controlling the degree of the influence of the inductor.

In general, according to one embodiment, a power supply circuit includes:a first switch, a second switch, an inductor, a series circuit, a second resistor, and a control signal circuit. The first and second switches are connected between a first terminal and a second terminal and to each other at an output node. The inductor is connected between the output node and an output terminal. The series circuit includes a first resistor, one end of which is connected to the output node, and a capacitor whose one end is connected to the output terminal. The first resistor and the capacitor are connected to each other at a common connection node. The second resistor is connected in parallel with the capacitor. The control circuit compares a potential at the common connection node with a reference voltage and generates at least one control signal for switching at least the first switch on the basis of the comparison.

Hereinafter, power supply circuits according to embodiments are described in detail with reference to the accompanying drawings. However, the present disclosure is not limited to those embodiments.

### First Embodiment

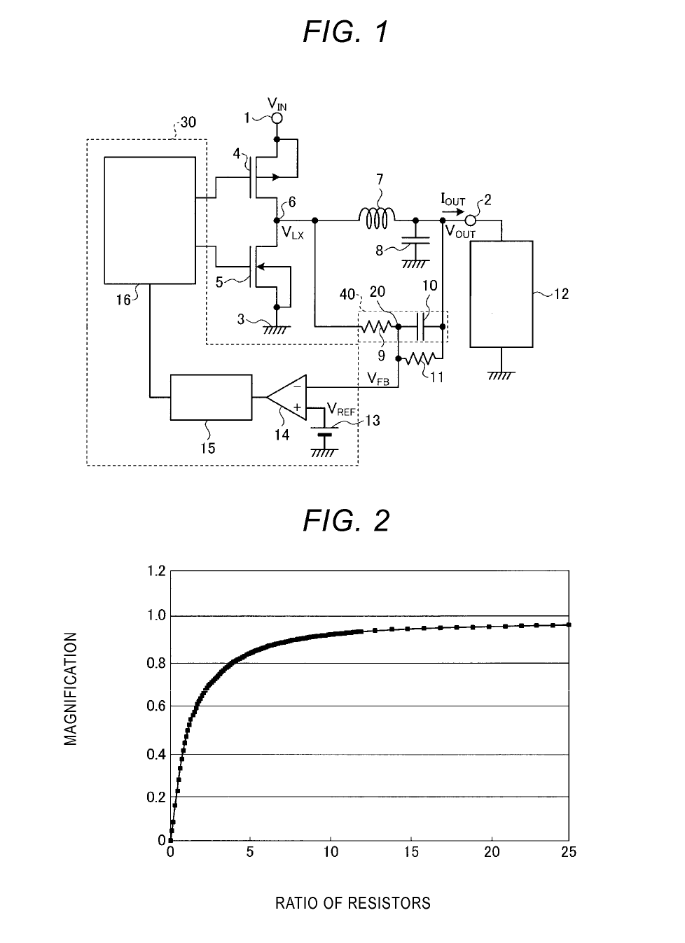

FIG. 1 is a view illustrating the configuration of a power supply circuit according to a first embodiment. The power supply circuit of the present embodiment has an input terminal 1 to which a DC input voltage V_{IN} is applied. The input terminal 1 is connected to the source electrode and back gate electrode of a PMOS transistor 4, which constitutes a high-side switch. The drain electrode of the PMOS transistor 4 is connected to an output node 6. The output node 6 is connected to the drain electrode of an NMOS transistor 5, which constitutes a low-side switch. The source electrode and back gate electrode of the NMOS transistor 5 are connected to a ground terminal 3 to which a ground voltage is applied as a reference voltage.

The output node 6 is connected to one end of an inductor 7. The other end of the inductor 7 is connected to an output terminal 2. The output terminal 2 supplies an output voltage to a load 12. Between the output terminal 2 and the ground terminal 3, a smoothing capacitor 8 is connected. The output node 6 is connected to one end of a resistor 9. The other end of the resistor 9 is connected to a common connection node 20. The common connection node 20 is connected to one end of a capacitor 10 whose other end is connected to the output terminal 2.

The series connection of the resistor 9 and the capacitor 10 constitutes a low-pass filter 40. The PMOS transistor 4 and the NMOS transistor 5 are alternately turned on and off, generating a rectangular signal at the output node 6. The rectangular signal at the output node 6 is supplied to the low-pass filter 40 generating a triangular wave with a predetermined slope at the common connection node 20 of the resistor 9 and the capacitor 10. The values of the resistor 9 and the capacitor 10 in the low-pass filter 40, can be appropriately selected to have a time constant that adjusts the slope of the triangular wave. The capacitor 10 is connected in parallel with a resistor 11. That is, one end of the resistor 11 is connected to the common connection node 20, and the other end of the resistor 11 is connected to the output terminal 2. The capacitance of the capacitor 10 is set to a value smaller than the capacitance of the smoothing capacitor 8 to suppress power consumption.

The common connection node 20 is connected to the inverting input terminal of a comparator 14. The non-inverting input terminal of the comparator 14 is connected to a reference voltage source V_{REF} 13. The output of the comparator 14 is applied to a pulse generating circuit 15. Whenever a high-level output is supplied from the comparator 14, the pulse generating circuit 15 generates a pulse having a constant width, that is, a pulse having a constant high-level interval.

The output of the pulse generating circuit 15 is supplied to a timing adjustment circuit 16, which supplies drive signals to the gate electrodes of the PMOS transistor 4 and the NMOS transistor 5. The timing adjustment circuit 16 supplies drive signals to the gate electrodes of the PMOS transistor 4 and the NMOS transistor 5. The timing of the drive signals is adjusted to prevent the PMOS transistor 4 and the NMOS transistor 5 from turning on at the same time, thereby preventing a shoot-through current from being generated between the input terminal 1 and the ground terminal 3. The comparator 14, the pulse generating circuit 15, and the timing adjustment circuit 16 constitute a control circuit 30 for controlling turning on and off the PMOS transistor 4 constituting the high-side switch and the NMOS transistor 5 constituting the low-side switch.

The control circuit 30 compares a feedback voltage V_{FB} from the common connection node 20 with the reference voltage V_{REF} of the reference voltage source 13, and performs a control operation such that the feedback voltage V_{FB} becomes equal to the reference voltage V_{REF}. That is, in a case where the feedback voltage V_{FB} is lower than the reference voltage V_{REF}, the control circuit 30 operates to increase the duty cycle of the ON state of the PMOS transistor 4 constituting the high-side switch. In a case where the feedback voltage V_{FB} is higher than the reference voltage V_{REF}, the control circuit 30 operates to increase the duty cycle of the ON state of the NMOS transistor 5 constituting the low-side switch, and decrease the duty cycle of the ON state of the PMOS transistor 4.

If the output voltage and output current of the output terminal 2 are denoted by V_{OUT} and I_{OUT}, respectively, and the voltage of the output node 6, the resistance value of the resistor 9, and the resistance value of the resistor 11 are denoted by V_{LX}, R₉, and R₁₁, respectively, the feedback voltage V_{FB} of the common connection node 20 can be expressed by the following equation 1.

V_{FB}=V_{OUT}+(V_{LX}−V_{OUT})×(R₁₁/(R₉+R₁₁)) (1)

If the current to flow in the resistor 9 of the low-pass filter 40 is set to be sufficiently lower than the current to flow in the inductor 7, the voltage V_{LX} of the output node 6 can be expressed by the following equation 2.

V_{LX}=V_{OUT}+I_{OUT}×R₇ (2)

Here, R₇ represents the equivalent series resistance of the inductor 7. If the resistance value R₉ of the resistor 9 is set to a value sufficiently larger than the equivalent series resistance R₇ of the inductor 7, and similarly, the resistance value R₁₁ of the resistor 11 is set to a value sufficiently larger than the equivalent series resistance R₇ of the inductor 7, it is possible to make the current flowing in the resistor 9 in the low-pass filter 40, sufficiently smaller than the current flowing in the inductor 7.

Equation 2 can be rewritten according to the following equation 3.

V_{LX}−V_{OUT}=I_{OUT}×R₇ (3)

If equation 3 is substituted in equation 1, and equation 1 is then rewritten, the following equation 4 is obtained.

V_{FB}=V_{OUT}+I_{OUT}×R₇×R₁₁/(R₉+R₁₁) (4)

Since the control circuit 30 performs control such that the feedback voltage V_{FB} becomes equal to the reference voltage V_{REF}, equation 4 can be expressed according to the following equation 5.

V_{FB}=V_{REF}=V_{OUT}+I_{OUT}×R₇×R₁₁/(R₉+R₁₁) (5)

If equation 5 is rewritten, the following equation 6 can be obtained.

V_{OUT}=V_{REF}−I_{OUT}×R₇×R₁₁/(R₉+R₁₁) (6)

As expressed in equation 6, the influence of voltage drop by the inductor 7 is reduced to {R₁₁/(R₉+R₁₁)} times thereof by the resistor 9 and the resistor 11. Therefore, if the resistance values of the resistor 9 and the resistor 11 are appropriately selected, it is possible to reduce the influence of the inductor 7. Thus, control on the output voltage V_{OUT} based on comparison between the feedback voltage V_{FB} and the reference voltage V_{REF} is performed more accurately.

According to the first embodiment, the resistor 11 is connected in parallel with the capacitor 10 in the filter for generating the feedback voltage V_{FB}. As a result, it is possible to obtain an effect of reducing the influence of the inductor 7 on the output voltage V_{OUT}. Also, it is possible to control the output voltage V_{OUT} by appropriately setting the ratio of the resistance values of the resistor 9 and the resistor 11.

FIG. 2 is view illustrating the relation between the ratio of the resistor 9 in the filter and the resistor 11, and the decreasing rate, that is, magnification of the influence of the inductor 7. The magnification to decrease the influence of the inductor 7 is determined according to the value of {R₁₁/(R₉+R₁₁)} as shown in the above Equation 6. For this reason, it is possible to change the value of {R₁₁/(R₉+R₁₁)} from 0.05 up to 0.95 by changing the resistance value R₁₁ of the resistor 11 from 1/19 times to 19 times of the resistance value R₉ of the resistor 9 of the filter. That is, it is possible to control the magnification within a range from 0.05 at which the influence of the inductor 7 is substantially negligible up to 0.95 at which the influence of the inductor 7 appears substantially as it is, by changing the ratio of the resistor 11 to resistor 9 from about 1/20 up to about 20. If the resistor 11 with a small resistance value, i.e., one that is about 1/20 times that of the resistor 9 in the low-pass filter 40, is connected in parallel with the capacitor 10, it is possible to significantly reduce the influence of the inductor 7. The ratio of the resistance values of the resistor 9 and the resistor 11 can be set to control the output voltage V_{OUT} as shown in Equation 6.

### Second Embodiment

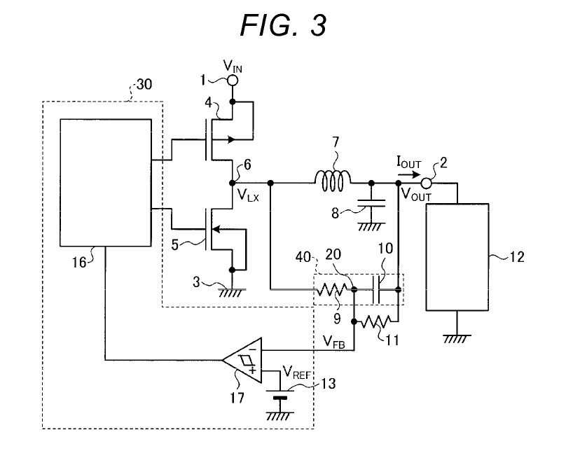

FIG. 3 is a view illustrating a power supply circuit according to a second embodiment. Components corresponding to those of the above described embodiment are denoted by the same reference symbols, and are not further described. In the power supply circuit of the present embodiment, the control circuit 30 includes a hysteresis comparator 17. To the inverting input terminal of the hysteresis comparator 17, the feedback voltage V_{FB} of the common connection node 20 is supplied, and to the non-inverting input terminal, the reference voltage V_{REF} of the reference voltage source 13 is supplied. The output of the hysteresis comparator 17 is supplied to a timing adjustment circuit 16.

The hysteresis comparator 17 compares the feedback voltage V_{FB} of the common connection node 20 with the reference voltage V_{REF} of the reference voltage source 13, and sends an output signal having a pulse width according to the comparison result. The control circuit 30 supplies a drive signal to the gate electrodes of the PMOS transistor 4 and the NMOS transistor 5 such that the feedback voltage V_{FB} becomes equal to the reference voltage V_{REF}. That is, in a case where the feedback voltage V_{FB} is lower than the reference voltage V_{REF}, the control circuit 30 operates to increase the duty cycle of the ON state of the PMOS transistor 4 constituting the high-side switch. On the contrary, in a case where the feedback voltage V_{FB} is higher than the reference voltage V_{REF}, the control circuit 30 operates to increase the duty cycle of the ON state of the NMOS transistor 5 constituting the low-side switch, and decrease the duty cycle of the ON state of the PMOS transistor 4.

In the present embodiment, the hysteresis comparator 17 outputs a signal having a pulse width according to the result of comparison between the feedback voltage V_{FB} and the reference voltage V_{REF}. Therefore, the pulse generating circuit 15 of the first embodiment is unnecessary. Even in the present embodiment, it is possible to reduce the influence of the inductor 7 on the output voltage V_{OUT} and control the output voltage V_{OUT} by appropriately setting the ratio of the resistor 9 in the low-pass filter 40 and the resistor 11 connected in parallel with the capacitor 10.

### Third Embodiment

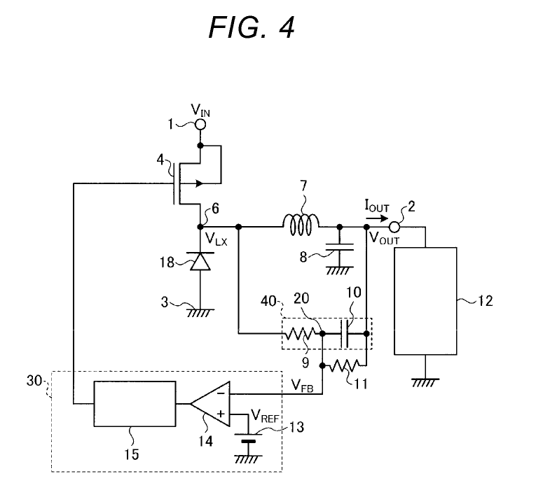

FIG. 4 is a view illustrating a power supply circuit according to a third embodiment. Components corresponding to those of the above described embodiments are denoted by the same reference symbols, and are not further described. In the present embodiment, instead of the NMOS transistor constituting the low-side switch, a diode 18 is included. That is, the cathode electrode of the diode 18 is connected to the output node 6, and the anode electrode of the diode 18 is connected to the ground terminal 3. The control circuit 30 supplies a drive signal to the gate electrode of the PMOS transistor 4 such that the feedback voltage V_{FB} becomes equal to the reference voltage V_{REF}. That is, in a case where the feedback voltage V_{FB} is lower than the reference voltage V_{REF}, the control circuit 30 operates to increase the duty cycle of the ON state of the PMOS transistor 4 constituting the high-side switch. On the contrary, in a case where the feedback voltage V_{FB} is higher than the reference voltage V_{REF}, the control circuit 30 operates to decrease the duty cycle of the ON state of the PMOS transistor 4.

In the present embodiment, a control signal from the control circuit 30 based on the result of comparison between the feedback voltage V_{FB} of the common connection node 20 and the reference voltage V_{REF} of the reference voltage source 13 is supplied only to the gate electrode of the PMOS transistor 4 constituting the high-side switch. In a state where the PMOS transistor 4 is off, since a current flows into the inductor 7 through the diode 18, it is unnecessary to adjust the timing of conduction with the PMOS transistor 4. Therefore, the timing adjustment circuit 16 of the control circuit 30 of the above described embodiments is unnecessary. Even in the power supply circuit of the present embodiment, it is possible to reduce the influence of the inductor 7 on the output voltage V_{OUT} and control the output voltage V_{OUT} by appropriately setting the ratio of the resistor 9 in the low-pass filter 40 and the resistor 11 connected in parallel with the capacitor 10.

It is possible to use a variable resistor for at least one of the resistor 9 and the resistor 11 to appropriately adjust the ratio of the resistance values of the resistor 9 and the resistor 11 to control the influence of the inductor 7 after the power supply circuit is configured. For example, it is possible to configure a variable resistor by connecting a plurality of stages of configurations, in each of which a resistor is connected in series with a source-drain path of a MOS transistor, in parallel. In this case, it is possible to appropriately adjust the number of MOS transistors to be turned on, thereby adjusting the resistance value of the variable resistor. A control circuit for supplying a control signal for turning on or off each of the MOS transistors to the gate of each MOS transistor can be used to adjust the resistance value of the variable resistor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power supply circuit comprising:
a first switch and a second switch connected in series between a first terminal and a second terminal and to each other at an output node, at least the first switch receiving a control signal;
an inductor connected between the output node and an output terminal;
a series circuit including a capacitor and a first resistor connected to each other at a common connection node, the series circuit connected in parallel with the inductor;
a second resistor connected in parallel with the capacitor of the series circuit; and
a control signal circuit connected to the common connection node and a reference voltage, and configured to generate a comparison between a potential of the common connection node and the reference voltage and to generate at least one control signal based on the comparison.

2. The power supply circuit according to claim 1, wherein a value of the second resistor is set between about 1/20 times and about 20 times of a value of the first resistor.

3. The power supply circuit according to claim 1, wherein the control signal circuit includes a comparator comparing the potential of the common connection node with the reference voltage.

4. The power supply circuit according to claim 3, wherein the control signal circuit includes a pulse generating circuit generating a pulse in response to an output of the comparator.

5. The power supply circuit according to claim 1, wherein the control signal circuit includes a hysteresis comparator comparing the potential of the common connection node with the reference voltage.

6. The power supply circuit according to claim 1, wherein at least one of the first resistor or the second resistor is a variable resistor.

7. The power supply circuit according to claim 1,
wherein the control signal circuit generates a control signal for each switch; and
wherein the first switch is a PMOS transistor and the second switch is an NMOS transistor and the control signal for each switch is received on the gate of each transistor.

8. The power supply circuit according to claim 1,
wherein the first switch is an PMOS transistor and the second switch is a diode having a cathode connected to the reference voltage and an anode connected to the output node; and
wherein the gate of the PMOS transistor receives the control signal.

9. A control circuit for a power supply that includes a first switch and a second switch connected in series between a first terminal and a second terminal and to each other at an output node, at least the first switch receiving a control signal and an inductor connected between the output node and an output terminal, the control circuit comprising:
a series circuit including a capacitor and a first resistor connected to each other at a common connection node, the series circuit connected in parallel with the inductor; a second resistor connected in parallel with the capacitor of the series circuit; and
a control signal circuit connected to the common connection node and a reference voltage, and configured to generate a comparison between a potential of the common connection node and the reference voltage and to generate at least one control signal based on the comparison.

10. The power supply circuit according to claim 9, wherein a value of the second resistor is set between 1/20 times and 20 times of a value of the first resistor.

11. The power supply circuit according to claim 9, wherein the control signal circuit includes a comparator comparing the potential of the common connection node with the reference voltage.

12. The power supply circuit according to claim 9, wherein the control signal circuit includes a hysteresis comparator comparing the potential of the common connection node with the reference voltage.

13. The power supply circuit according to claim 9, wherein at least one of the first resistor or the second resistor is a variable resistor.

14. The power supply circuit according to claim 9,
wherein the control signal circuit generates a control signal for each switch; and
wherein the first switch is a PMOS transistor and the second switch is an NMOS transistor and the control signal for each switch is received on the gate of each transistor.

15. The power supply circuit according to claim 9,
wherein the first switch is an PMOS transistor and the second switch is a diode having a cathode connected to the reference voltage and an anode connected to the output node; and
wherein the gate of the PMOS transistor receives the control signal.

16. A method for controlling a power supply, the method comprising:
supplying current, via a switching element, to an inductor connected between an output node and an output terminal, wherein the switching element is connected between a supply voltage and the output node and switches in response to a control signal;
generating a voltage at a common connection node of an RC circuit that is connected in parallel with the inductor, the RC circuit including a first resistor having a first end connected to the output node and a second end connected to the common connection node, a capacitor having a first end connected to the output terminal and a second end connected to the common connection node, and a second resistor connected in parallel with the capacitor; and
comparing the generated voltage with a reference voltage to generate the control signal for the switching element.

17. The method according to claim 16, wherein a value of the second resistor is set between 1/20 times and 20 times of a value of the first resistor.

18. The method according to claim 16, wherein at least one of the first resistor or the second resistor is a variable resistor.

19. The method according to claim 16, wherein the generated voltage is compared with the reference voltage using a comparator.

20. The method according to claim 19, wherein the comparator comprises a hysteresis comparator.
